(19) United States
(12) Patent Application Publication
(10) Pub. No.: US 2015/0009355 A1
(43) Pub. Date: Jan. 8, 2015

(54) MOTION ADAPTIVE CMOS IMAGING SYSTEM

(71) Applicant: Himax Imaging Limited, Tainan City (TW)

(72) Inventor: Yuan-Chih Peng, Tainan City (TW)

(21) Appl. No.: 13/935,873

(22) Filed: Jul. 5, 2013

(51) Int. Cl. H04N 5/355; H04N 5/232; H04N 5/235

(52) U.S. Cl. CPC H04N 5/35536; H04N 5/2355; H04N 5/23212; H04N 5/2352
USPC 348/222.1

(57) ABSTRACT

The present disclosure provides a motion adaptive imaging control method applied to a high dynamic range CMOS imaging system. In the motion adaptive imaging control method, first a motion index of each pixel of a high dynamic range (HDR) image data is determined according to a first image data of a scene corresponding to a first exposure value and a second image data of the scene corresponding to a second exposure value. Then, any combination of an auto exposure control process, an auto focus control process and a contrast enhancement process is performed according to the motion index of each pixel, the first image data and the second image data.

### BACKGROUND OF THE INVENTION

1. Field of the Invention

The invention relates to motion adaptive imaging control and more particularly to performing motion adaptive imaging control on a CMOS (Complementary Metal Oxide Semiconductor) imaging system.

2. Description of the Related Art

An imaging sensor, converting an optical image into an electrical signal, can be generally classified into a charge coupled device (CCD) and a complementary metal oxide semiconductor (CMOS) image sensor. A CMOS imaging sensor has advantages of low consumption, low production cost and high integration. In addition, it's easy to integrate the CMOS imaging sensor with other digital circuits to perform functions such as auto exposure control, auto focus control, contrast enhancement and noise reduction. Therefore, the CMOS imaging sensor is widely used in electrical apparatuses, especially in surveillance devices and cameras of portable electronic devices like mobile phones.

FIG. 1 is a block diagram of a known CMOS imaging system 10. The CMOS imaging system comprises a lens 100, a pixel array 110, an image processor 120 coupled to the pixel array 110, an auto exposure control unit 130 coupled to the pixel array 110 and the image processor 120, and an auto focus control unit coupled to the lens 110 and the image processor 120. The image processor 120 comprises an exposure statistics module 122 coupled to the auto exposure control unit, a focus statistics module 123 coupled to the auto focus control unit 140, and a contrast enhancement module 124.

The exposure statistics module 122 uses exposure metering to collect exposure statistics of image data captured by the pixel array 110. FIG. 2A is a block diagram of a multi-window image IMG1 used in the exposure metering. The image IMG1 captured by the pixel array 110 is divided into rows and columns of windows WD1˜WD25. Each window comprises at least one pixel. FIG. 2B is a block diagram of an exemplary weighting set IMG2 applied to the multi-window image in FIG. 2A. The exposure statistics module 122 multiplies pixel values of pixels in a window by the weighting corresponding to the window and accumulates the multiplied pixel values to obtain window exposure statistics for the window. After that, the exposure statistics module 122 sums up window exposure statistics of all the windows to obtain the exposure statistics of the image IMG1. For example, pixel values of pixels in the window WD7 are multiplied by 0.5 and pixel values of pixels in the window WD13 are multiplied by 1. After that, the auto exposure control unit 130 receives the exposure statistics from the exposure statistics module 122 and then performs the auto exposure control process to adjust the exposure value of the pixel array 110 when capturing images based on the exposure statistics.

The focus statistics module 123 uses an evaluation function, such as a Laplacian evaluation function or an entropy function, to collect focus statistics of the image captured by the pixel array 110 so as to measure the quality of the image in an auto focus control process. The auto focus control unit 140 receives the focus statistics from the focus statistics module 123 and then performs the auto focus control process to adjust the focal length of the lens 100 based on the focus statistics. The contrast enhancement module 124 performs a contrast enhancement process to enhance the contrast of the image by using histogram equalization.

Varying weightings are applied to the calculation of statistics, such as the exposure statistics, the focus statistics and the histogram described above, to tally with different requirements under different circumstances. The weightings may be predetermined or predefined according to different circumstances. In some special applications, such as in surveillance devices and monitor cameras, objects in motion are preferred to be shown as detailed as possible.

Furthermore, in order to well present details in the image, the dynamic range of the image is also an important factor to be considered. In some known technologies, image data with different exposure values are used to obtain high dynamic range (HDR) or enhances dynamic range (EDR) images.

### BRIEF SUMMARY OF THE INVENTION

In view of this, the invention provides a motion adaptive CMOS imaging system and a motion adaptive imaging control method to adjust weightings of statistics used in image processing according to motion indexes of an image while improving the dynamic range of the image so as to preferably show objects in motion in the image.

In one embodiment, the invention provides a motion adaptive imaging control method applied to a complementary metal oxide semiconductor (CMOS) imaging system, comprising: obtaining a first image data of a scene corresponding to a first exposure value and a second image data of the scene corresponding to a second exposure value, wherein the first exposure value is larger than the second exposure value; determining a motion index of each pixel of a high dynamic range (HDR) image data according to a pixel value difference between a first pixel value of a corresponding pixel of the first image data and a second pixel value of a corresponding pixel of the second image data; and performing any combination of an auto exposure control process, an auto focus control process and a contrast enhancement process according to the motion index of each pixel, the first image data and the second image data.

In another embodiment, the invention provides a motion adaptive complementary metal oxide semiconductor (CMOS) imaging system, comprising: a lens; an image sensing array, capturing image data of a scene using a first exposure value and a second exposure value, wherein the first exposure value is larger than the second exposure value; and an image processor, coupled to the image sensing array, receiving the image data and generating a first image data of the scene corresponding to the first exposure value and a second image data of the scene corresponding to the second exposure value, comprising: a motion detector, determining a motion index of each pixel of a high dynamic range (HDR) image data according to a pixel value difference between a first pixel value of a corresponding pixel of the first image data and a second pixel value of a corresponding pixel of the second image data, wherein the motion adaptive CMOS imaging system performs any combination of an auto exposure control process, an auto focus control process and a contrast enhancement process according to the motion index of each pixel, the first image data and the second image data.

In still another embodiment, the invention provides a computer program product, embodied in a non-transitory storage medium and loaded by an electronic apparatus to execute a motion adaptive imaging control method applied to a complementary metal oxide semiconductor (CMOS) imaging system, comprising: a first code, obtaining a first image data of a scene corresponding to a first exposure value and a second image data of the scene corresponding to a second exposure value, wherein the first exposure value is larger than the second exposure value; a second code, determining a motion index of each pixel of a high dynamic range (HDR) image data according to a pixel value difference between a first pixel value of a corresponding pixel of the first image data and a second pixel value of a corresponding pixel of the second image data; and a third code, performing any combination of an auto exposure control process, an auto focus control process and a contrast enhancement process according to the motion index of each pixel, the first image data and the second image data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a known CMOS imaging system;

FIG. 2A is a block diagram of a multi-window image used in exposure metering;

FIG. 2B is a block diagram of an exemplary weighting set applied to the multi-window image in FIG. 2A;

FIG. 3 is a flow chart of a motion adaptive imaging control method applied to a CMOS imaging system according to an embodiment of the invention;

FIG. 4 is a block diagram of a motion adaptive CMOS imaging system according to an embodiment of the invention;

FIG. 5A is a block diagram of a first image data corresponding to a first exposure value according to an embodiment of the invention;

FIG. 5B is a block diagram of a second image data corresponding to a second exposure value according to an embodiment of the invention;

FIG. 6 is a block diagram of an exemplary motion detector according to an embodiment of the invention;

FIG. 7 is a block diagram showing a relationship between a pixel value difference and a motion index;

FIG. 8 is a block diagram of an exemplary motion detector according to an embodiment of the invention;

FIG. 9A is a block diagram of an exemplary exposure statistics module according to an embodiment of the invention;

FIG. 9B is a block diagram of an exposure statistics module for a window in the exposure statistics module in FIG. 9A;

FIG. 10A is a block diagram of an exemplary exposure statistics module according to an embodiment of the invention;

FIG. 10B is a block diagram of an exposure statistics module for a window in the exposure statistics module in FIG. 10A;

FIG. 10C is a block diagram of a weighting generator for a window in the exposure statistics module in FIG. 10A;

FIG. 11 is a block diagram of a histogram according to an embodiment of the invention.

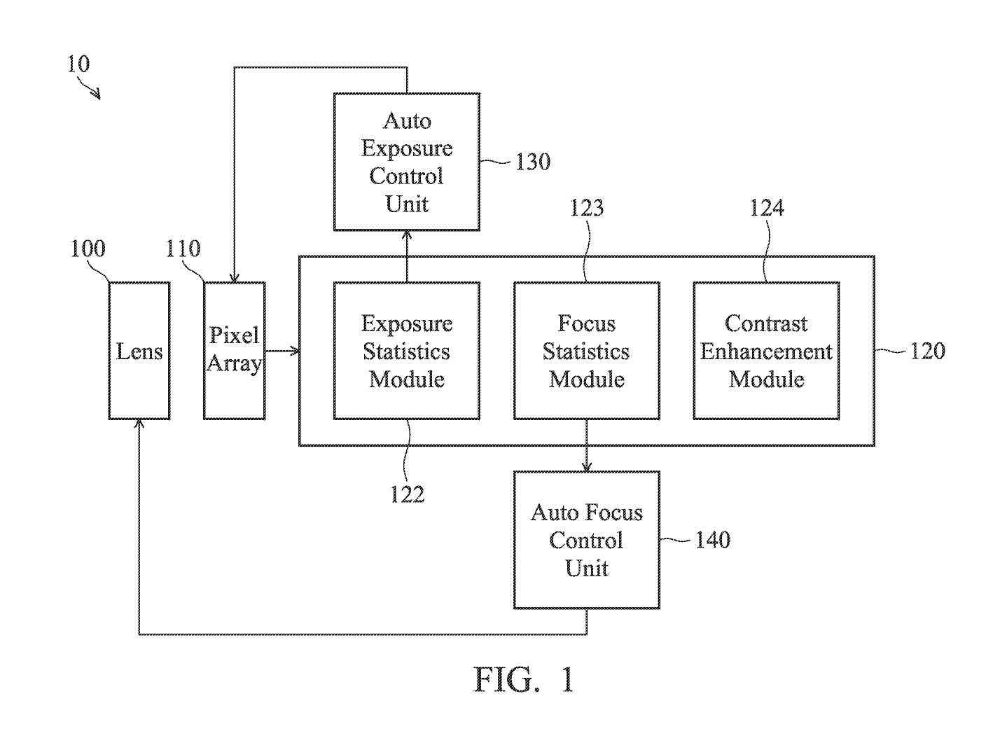

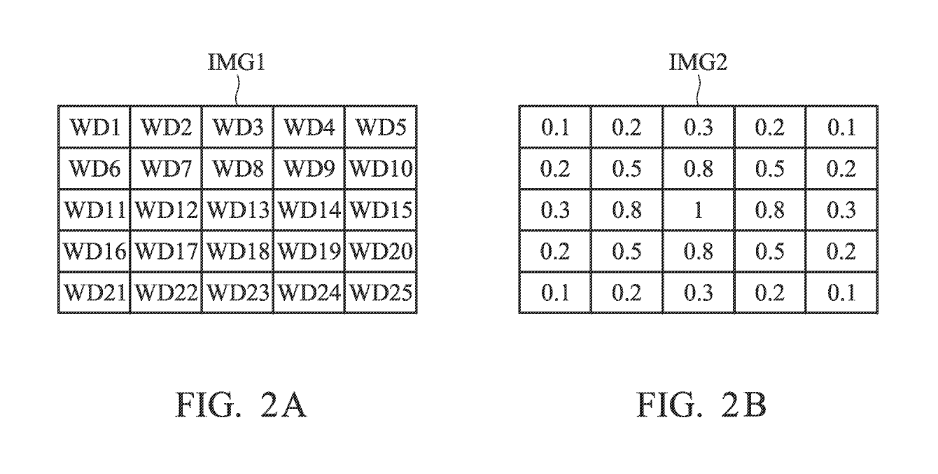

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

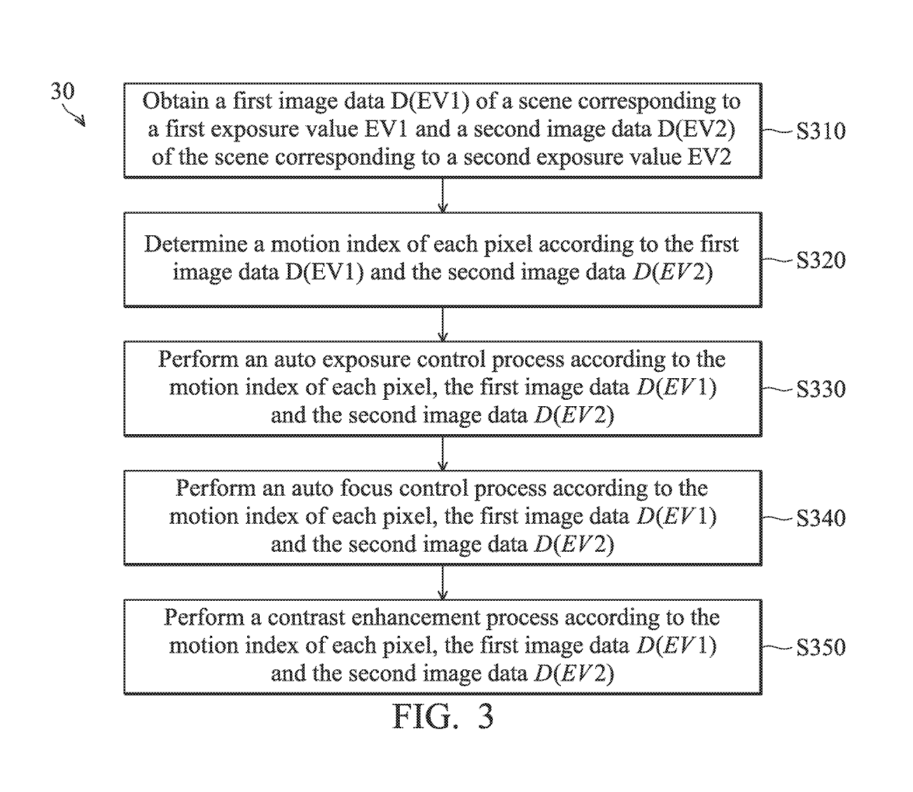

FIG. 3 is a flow chart of a motion adaptive imaging control method 30 applied to a CMOS imaging system according to an embodiment of the invention. In step S310, a first image data D(EV1) of a scene corresponding to a first exposure value EV1 and a second image data D(EV2) of the scene corresponding to a second exposure value EV2 are obtained. In the disclosure, the first exposure value EV1 is larger than the second exposure value EV2. In step S320, a motion index of each pixel of a HDR image data is determined according to a pixel value difference between a first pixel value of a corresponding pixel of the first image data D(EV1) and a second pixel value of a corresponding pixel of the second image data D(EV2). Details of determination of the motion index of each pixel will be described later. Then, in step S330, an auto exposure control process is performed according to the motion index of each pixel, the first image data D(EV1) and the second image data D(EV2) to adjust the first exposure value EV1 and the second exposure value EV2. Moreover, in step S340, an auto focus control process is performed according to the motion index of each pixel, the first image data D(EV1) and the second image data D(EV2) to adjust the focal length. Furthermore, in steps S350, a contrast enhancement process is performed according to the motion index of each pixel, the first image data D(EV1) and the second image data D(EV2) to enhance a contrast of the HDR image data. Details of the auto exposure control process, the auto focus control process and the contrast enhancement process will be described later. Though steps S330˜S350 can be performed in the order as shown in FIG. 3, the invention is not limited thereto. For example, steps S330˜S350 can be integrated into one single step.

In addition, though the motion adaptive adjustment can be applied to the auto exposure control process, the auto focus control process and the contrast enhancement process, as shown in steps S330˜S350, the invention is not limited thereto. For example, the motion adaptive adjustment may be applied to any combination of the auto exposure control process, the auto focus control process and the contrast enhancement process.

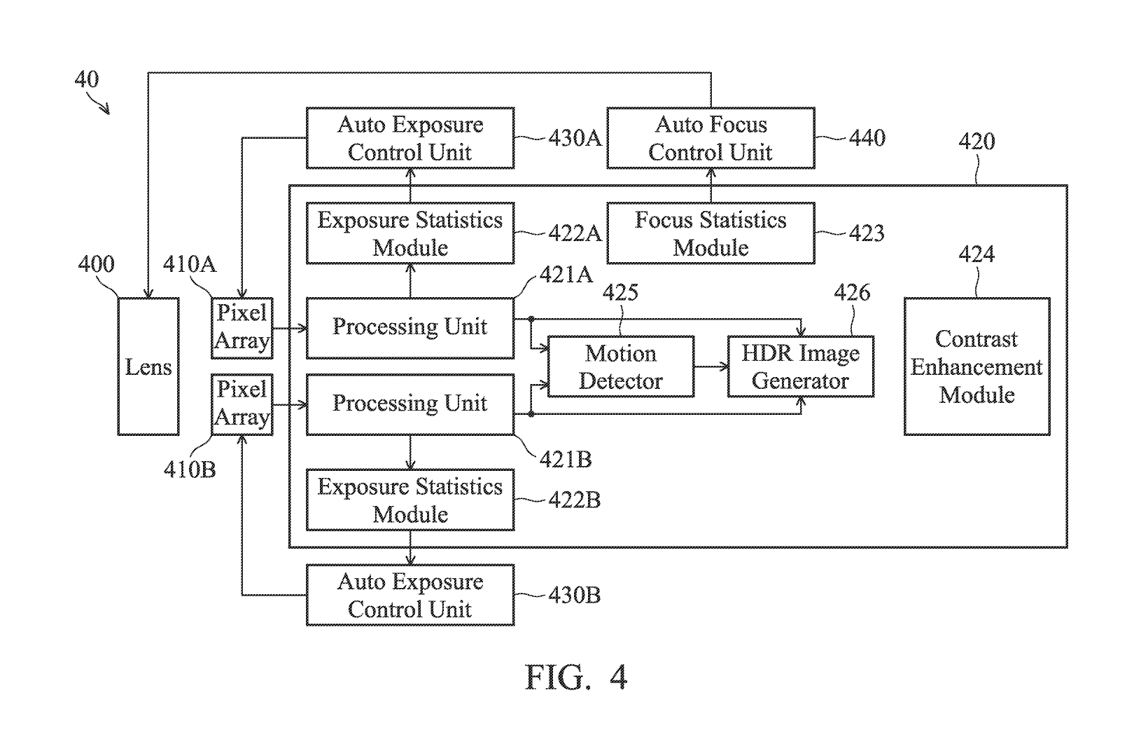

FIG. 4 is a block diagram of a motion adaptive CMOS imaging system 40 according to an embodiment of the invention. The motion adaptive CMOS imaging system 40 comprises a lens 400, pixel arrays (image sensing arrays) 410A and 410B, an image processor 420, auto exposure control units 430A and 430B and an auto focus control unit 440. The image processor 420 comprises processing units 421A and 421B, exposure statistics modules 422A and 422B, a focus statistics module 423, a contrast enhancement module 424, a motion detector 425 and a HDR image generator. The image processor 420 may further comprise other modules such as a demosaicking module, a gamma correction module and other image signal processing modules. Modules and units in the motion adaptive CMOS imaging system 40 take the form of an image processing hardware (ex: an image processing circuitry), software stored on a non-transitory computer readable medium and executable by a data processor, or a combination thereof, and are configured to perform functions described below.

The pixel arrays 410A and 410B in collaboration with the lens 400 are used to capture image data of a scene using the first exposure value EV1 and the second exposure value EV2. The processing units 421A and 421B receives the captured image data and generate the first image data D(EV1) and the second image data D(EV2), respectively. Then, the motion detector 425 receives the first image data D(EV1) from the processing unit 421A and the second image data D(EV2) from the processing unit 421B and determines the motion index of each pixel of the HDR image data according to the pixel value difference between the first pixel value of the corresponding pixel of the first image data D(EV1) and the second pixel value of the corresponding pixel of the second image data D(EV2).

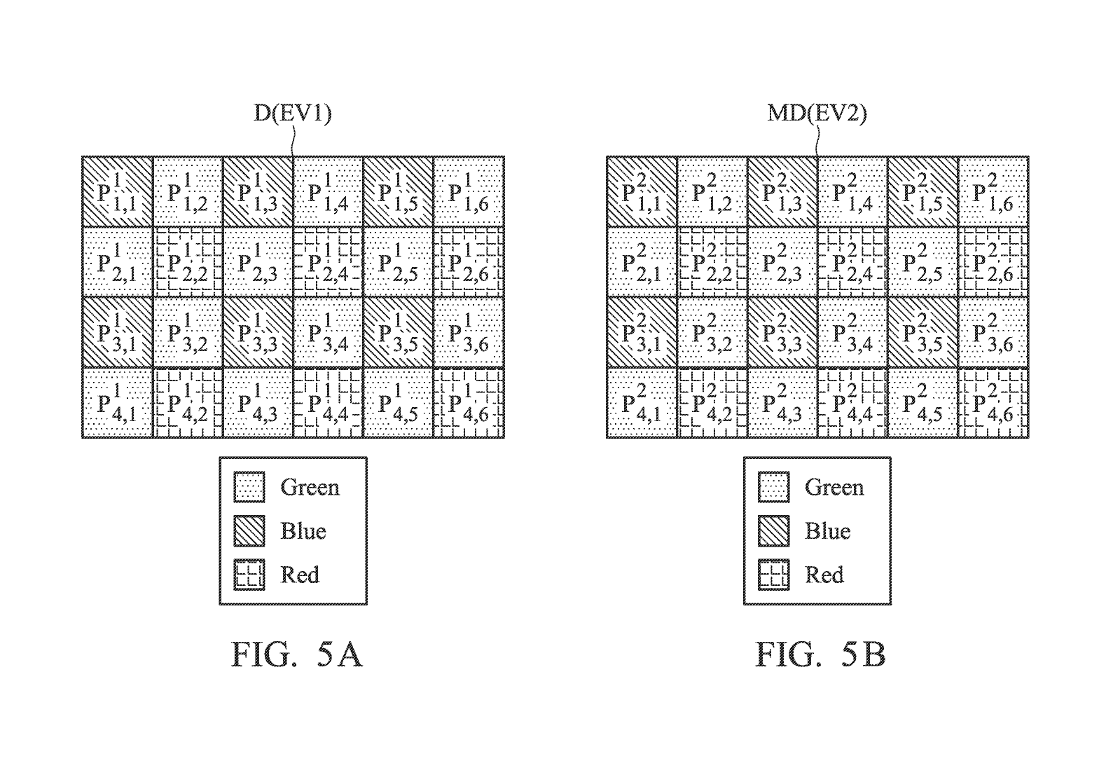

FIG. 5A is a block diagram of the first image data D(EV1) corresponding to the first exposure value EV1 according to an embodiment of the invention. FIG. 5B is a block diagram of the second image data D(EV2) corresponding to the second exposure value EV2 according to an embodiment of the invention. Though the image data in FIG. 5A and FIG. 5B takes the form of Bayer pattern, the invention is not limited thereto. In FIG. 5A, P¹_{i,j} denotes a pixel value of a pixel at the position (i,j) of the first image data D(EV1). Similarly, in FIG. 5B, P²_{i,j} denotes a pixel value of a pixel at the position (i,j) of the second image data D(EV2). The first image data D(EV1), the second image data D(EV2) and the HDR image data have the same size. The pixel value in the disclosure may refer to a colored pixel value or a luminance value (Y pixel value). Note that pixel values corresponding to the second exposure value EV2 have to be normalized according to the first exposure value EV1 and the second exposure value EV2. In the disclosure, the second image data D(EV2) comprises normalized pixel values, that is, each pixel value of the second image data D(EV2) is equal to an original pixel value corresponding to the second exposure value EV2 multiplied by 2^{EV1-EV2}.

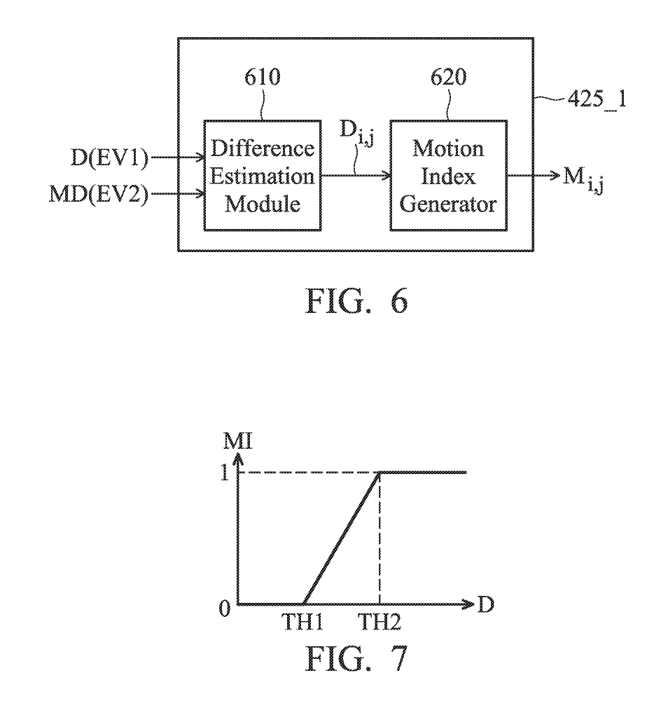

FIG. 6 is a block diagram of an exemplary motion detector 425_1 according to an embodiment of the invention. The motion detector 425_1 comprises a difference estimation module 610 and a motion index generator 620. The difference estimation module 610 receives the first image data D(EV1) and the second image data D(EV2) and generates a pixel value difference D_{i,j} of each pixel of the HDR image data. Then the motion index generator 620 determines the motion index M_{i,j} of each pixel of the HDR image data according to the pixel value difference D_{i,j}. The pixel value difference D_{i,j} is calculated according to:

D_{i,j}=4|P¹_{i,j}−P²_{i,j}|+2(|P¹_{i-1,j}−P²_{i-1,j}|+|P¹_{i+1,j}−P²_{i+1,j}|+|P¹_{i,j-1}−P²_{i,j-1}|+|P¹_{i,j+1}−P²_{i,j+1}|)+(|P¹_{i-1,j-1}−P²_{i-1,j-1}|+|P¹_{i-1,j+1}−P²_{i-1,j+1}|+|P¹_{i+1,j-1}−P²_{i+1,j-1}|+|P¹_{i+1,j+1}−P²_{i+1,j+1}|).

Take a pixel at the position (3, 3) of the HDR image data as an example, the pixel value difference D_{3,3} is calculated according to:

D_{3,3}=4|P¹_{3,3}−P²_{3,3}|+2(|P¹_{2,3}−P²_{2,3}|+|P¹_{4,3}−P²_{4,3}|+|P¹_{3,2}−P²_{3,2}|+|P¹_{3,4}−P²_{3,4}|)+(|P¹_{2,2}−P²_{2,2}|+|P¹_{2,4}−P²_{2,4}|+|P¹_{4,2}−P²_{4,2}|+|P¹_{4,4}−P²_{4,4}|).

FIG. 7 is a block diagram showing a relationship between a pixel value difference D and a motion index MI. The motion index generator 620 receives pixel value difference D_{i,j} of each pixel and determines the motion index M_{i,j} of each pixel according to the pixel value difference D_{i,j} based on the relationship shown in FIG. 7. As shown in FIG. 7, if a pixel value difference is smaller than or equal to the first threshold value TH1, the corresponding motion index is 0. If a pixel value difference is larger than or equal to the second threshold value TH2, the corresponding motion index is 1. Furthermore, if a pixel value difference is larger than the first threshold value TH1 and smaller than the second threshold value TH2, the corresponding motion index is a value larger than 0 and smaller than 1, and the larger the pixel value difference is, the larger the motion index is. For example, if a pixel value difference X is larger than the first threshold value TH1 and smaller than the second threshold value TH2, the corresponding motion index is equal to

$$\frac{X - TH 1}{TH 2 - TH 1} .$$

The threshold values TH1 and TH2 may be determined base on the noise tolerance. Though the relationship between the motion index and the pixel value difference in an interval of the threshold values TH1 and TH2 is linear in FIG. 7, the invention is not limited thereto.

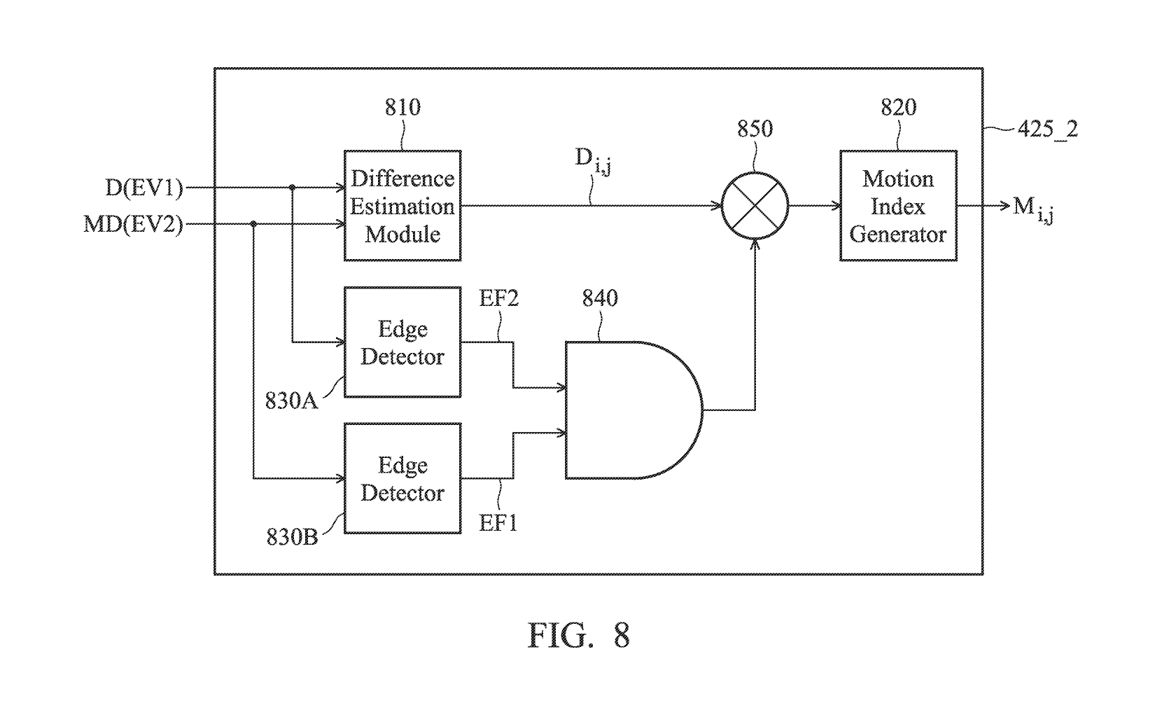

FIG. 8 is a block diagram of another exemplary motion detector 4252 according to an embodiment of the invention. The motion detector 425_2 comprises a difference estimation module 810, edge detectors 830A and 830B, an AND operator 840, a multiplier 850 and a motion index generator 820. The difference estimation module 810, similar to the difference estimation module 610 in FIG. 6, receives the first image data D(EV1) and the second image data D(EV2) and generates the pixel value difference D_{i,j} of each pixel of the HDR image data. The edge detector 830A receives the first image data D(EV1) and calculates an edge value of each pixel of the first image data D(EV1) to determine an edge flag EF¹_{i,j} so as to determine whether the pixel belongs to an edge. For example, an edge value EV(P¹_{3,3}) of a pixel at the position (3,3) of the first image data D(EV1) is determined according to:

EV(P¹_{3,3})=|P¹_{2,3}−P¹_{4,3}|+|P¹_{3,2}−P¹_{3,4}|.

If the edge value EF¹_{i,j} is larger than an edge threshold value, the corresponding edge flag EF¹_{i,j} outputted by the edge detector 830A is 1. If the edge value EF¹_{i,j} is not larger than the edge threshold value, the corresponding edge flag EF¹_{i,j} is 0. The edge detector 830B receives the second image data D(EV2) and calculates an edge value of each pixel of the second image data D(EV2) to determine an edge flag EF²_{i,j} so as to determine whether the pixel belongs to an edge. The operation of the edge detector 830B is similar to that of the edge detector 830A and will not be described again.

The AND operator 840 receives the edge flag EF¹_{i,j} and the edge flag EF²_{i,j} and outputs, to the multiplier 850, a difference weighting based on the AND operation of the edge flag EF¹_{i,j} and the edge flag EF²_{i,j}. For example, if the edge flag EF¹_{i,j} is 1 and the edge flag EF²_{i,j} is 0, the difference weighting outputted by the AND operator 840 is 0. Then, the multiplier 850 multiplies the pixel value difference D_{i,j} by the corresponding difference weighting and output the multiplied pixel value difference to the motion index generator 820. The motion index generator 820 determines the motion index M_{i,j} according to the pixel value difference D_{i,j} multiplied by the corresponding difference weighting based on a relationship between the pixel value difference and the motion index, such as the relationship shown in FIG. 7.

Referring back to FIG. 4, the HDR image generator 426 determines a pixel value of each pixel of the HDR image data according to the first pixel value of the corresponding pixel of the first image data D(EV1), the second pixel value of the corresponding pixel of the second image data D(EV2) and the corresponding motion index. The exposure statistics module 422A collects first exposure statistics ES1 of the first image data D(EV1) and the exposure statistics module 422B collects second exposure statistics ES2 of the second t image data D(EV2). Then, the auto exposure control unit 430A performs the auto exposure control process based on the first exposure statistics ES1 to adjust the first exposure value EV1 and the auto exposure control unit 430B performs the auto exposure control process based on the second exposure statistics ES2 to adjust the second exposure value EV2. The first exposure statistics ES1 and the second exposure statistics ES2 are calculated according to:

$$ES 1 = \frac{{\sum }_{x = 1}^{N} {\sum }_{i , j ∈ WDx} Wx \times {M}_{i , j} \times {P}_{i , j}^{1}}{{\sum }_{x = 1}^{N} {\sum }_{i , j ∈ WDx} {M}_{i , j}} ; and$$

$$ES 2 = \frac{{\sum }_{x = 1}^{N} {\sum }_{i , j ∈ WDx} Wx \times {M}_{i , j} \times {P}_{i , j}^{2}}{{\sum }_{x = 1}^{N} {\sum }_{i , j ∈ WDx} {M}_{i , j}} .$$

The first image data D(EV1) and the second image data D(EV2) are divided into N windows. N is a positive integer, such as 25. Wx denotes a weighting corresponding to a window WDx. Though there are two separate exposure statistics modules and two separate auto exposure control units in FIG. 4, the invention is not limited thereto. For example, the exposure statistics modules can be integrated into one single exposure statistics module and the auto exposure control units can be integrated into one single auto exposure control unit.

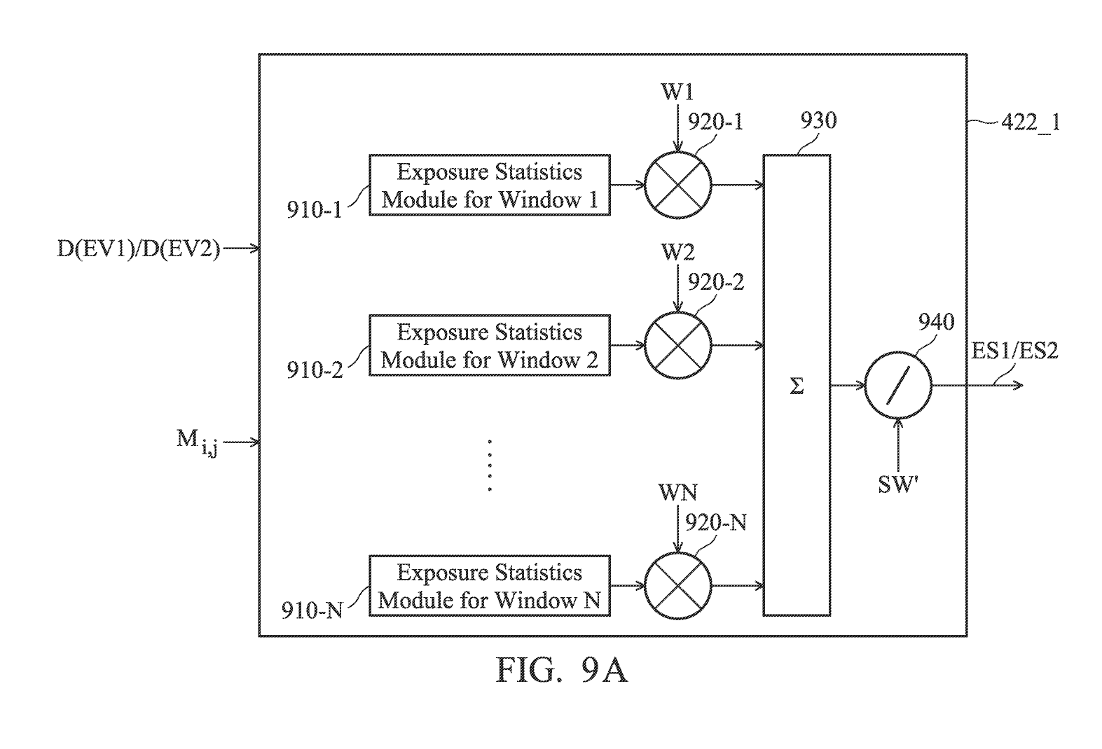

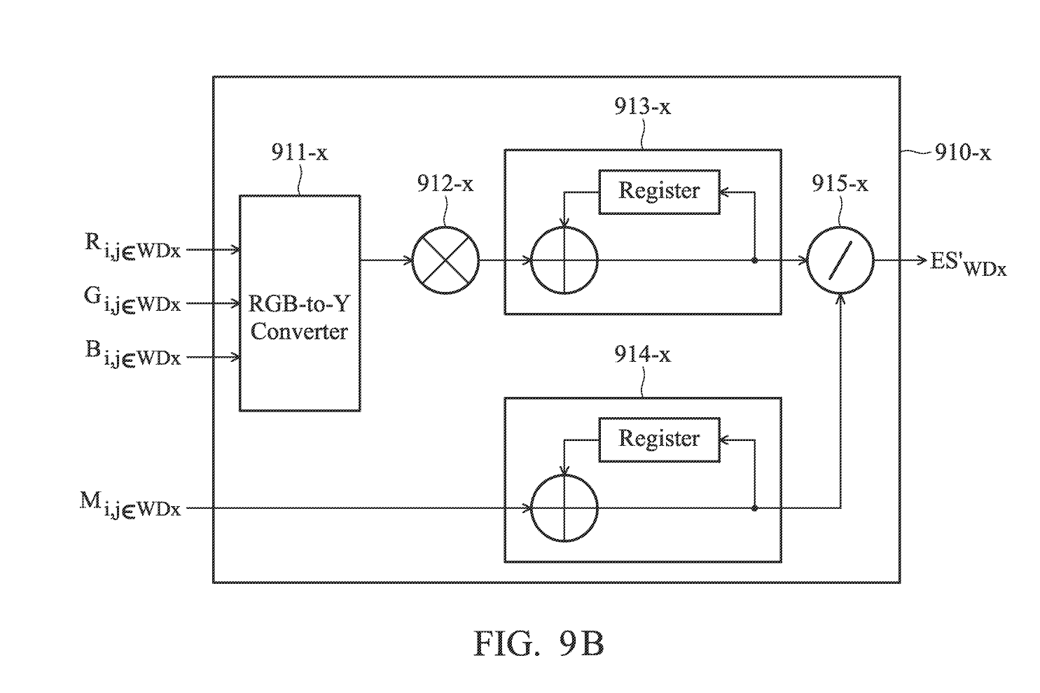

FIG. 9A is a block diagram of an exemplary exposure statistics module 422_1 according to an embodiment of the invention. The exposure statistics module 422_1 comprises exposure statistics sub-modules 910-1˜910-N, each of which corresponds to one of the N windows, multipliers 920-1˜920-N, a summation module 930 and a divider 940. Each exposure statistics sub-module collects motion adaptive window exposure statistics for the corresponding window. Each multiplier multiplies the motion adaptive window exposure statistics by the corresponding weighting. The summation module 930 sums up all the multiplied motion adaptive window exposure statistics. Then, the sum of all the multiplied motion adaptive window exposure statistics is divided by a weighting sum SW by the divider 940 to generate the exposure statistics. FIG. 9B is a block diagram of an exposure statistics sub-module 910-x for a window WDx in the exposure statistics module 422_1 in FIG. 9A. The exposure statistics sub-module 910-x comprises an RGB-to-Y converter 911-x, a multiplier 912-x, an accumulator 913-x, an accumulator 914-x, and a divider 915-x. The RGB-to-Y converter 911-x converts RGB pixel values into luminance values (referring to pixel values hereinafter). The multiplier 912-x multiplies the pixel value of each pixel in the window WDx by the corresponding motion index to generate a motion adaptive pixel value. The accumulator 913-x accumulates motion adaptive pixel values of all pixels in the window WDx to generate a motion adaptive pixel value sum. The accumulator 914-x accumulates motion indexes of all pixels in the window WDx to generate a motion index sum. The divider 915-x divides the motion adaptive pixel value sum by the motion index sum to generate the motion adaptive window exposure statistics ES′_{WDx}. Take the exposure statistics ES1 of an example, the exposure statistics ES1 is collected by the exposure statistics module 422_1 according to:

$${Y}_{i , j ∈ WDx} = 0.299 \times {R}_{i , j ∈ WDx} + 0.587 \times {G}_{i , j ∈ WDx} + 0.114 \times {B}_{i , j ∈ WDx} ;$$

$${ES}_{WDx}^{′} = \frac{\sum {M}_{i , j ∈ WDx} \times {Y}_{i , j ∈ WDx}}{\sum {M}_{i , j ∈ WDx}} ;$$

$$SW = {\sum }_{x = 1}^{N} Wx ; and$$

$$ES 1 = \frac{{\sum }_{x = 1}^{N} Ws \times {ES}_{WDx}^{′}}{SW} ,$$

wherein R_{i,jεWDx}, G_{i,jεWDx}, B_{i,jεWDx} and Y_{i,jεWDx} denote a red pixel value, a green pixel value, a blue pixel value and a luminance pixel value of a pixel at the position (i,j) of the window WDx, respectively.

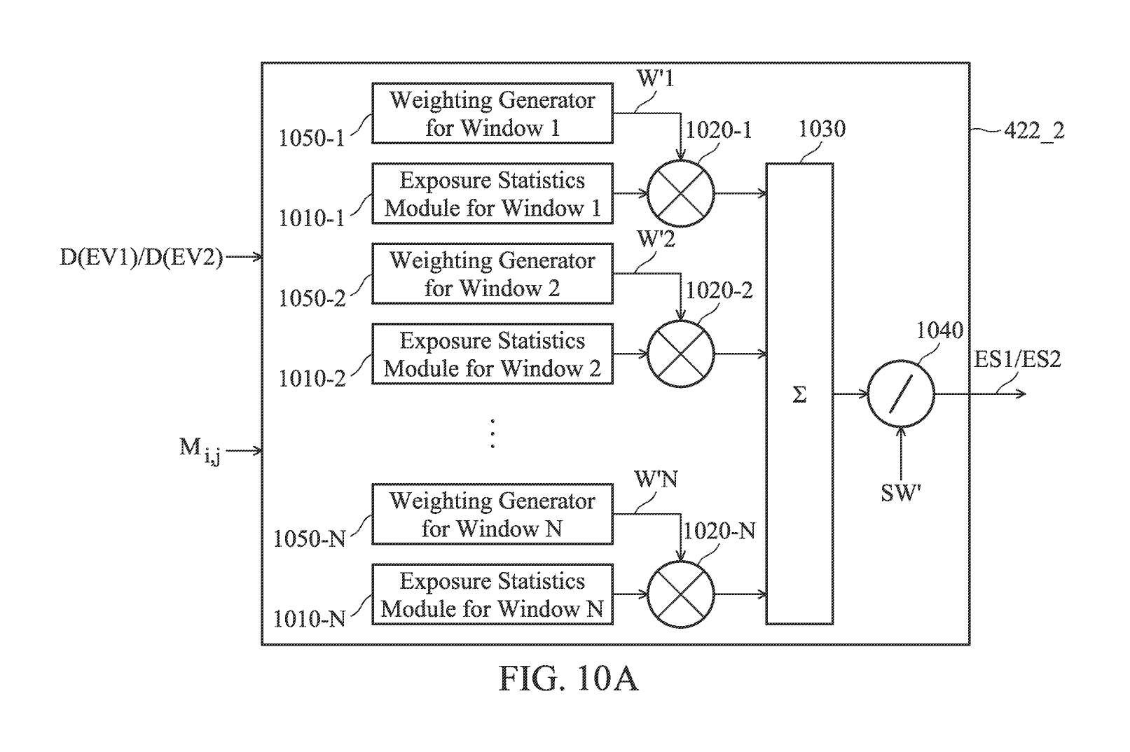

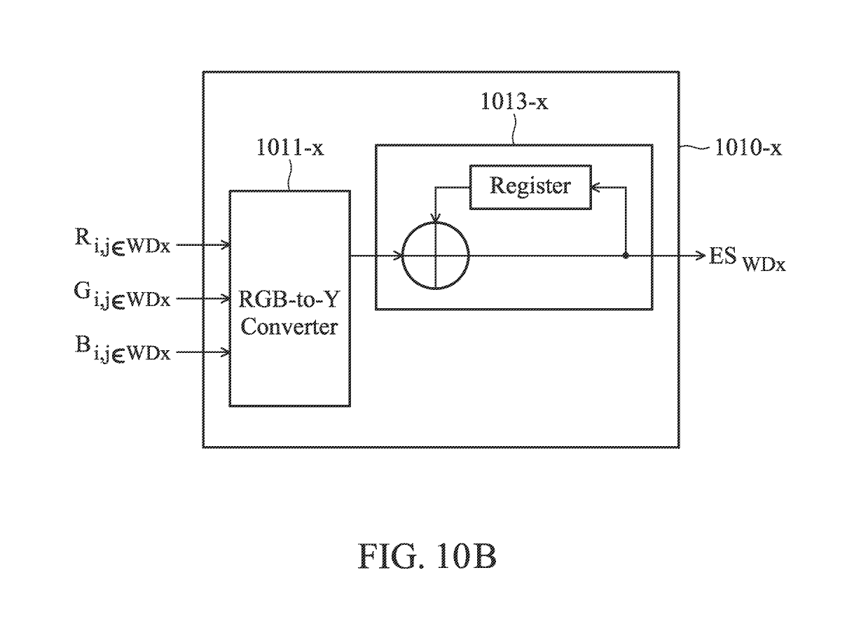

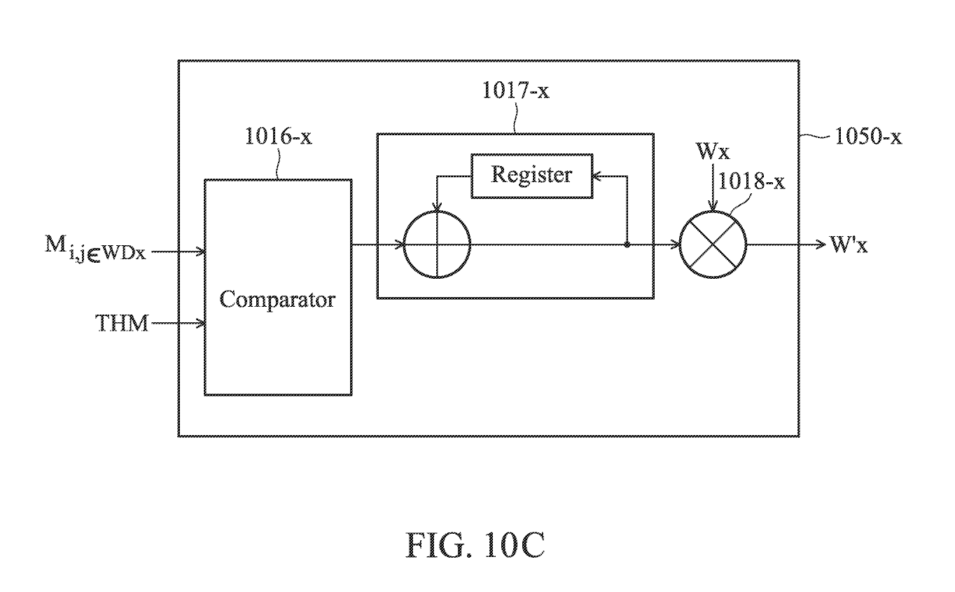

FIG. 10A is a block diagram of another exemplary exposure statistics module 4222 according to an embodiment of the invention. The exposure statistics module 422_2 comprises exposure statistics sub-modules 1010-1˜1010-N, each of which corresponds to one of the N windows, multipliers 1020-1˜1020-N, a summation module 1030, a divider 1040 and weighting generators 1050-1˜1050-N, each of which corresponds to one of the N windows. Each exposure statistics sub-module collects window exposure statistics for the corresponding window. Each weighting generator generates a motion adaptive weighting for the corresponding window. Each multiplier multiplies the window exposure statistics by the corresponding motion adaptive weighting. The summation module 1030 sums up all the multiplied window exposure statistics. Then, the sum of all the multiplied window exposure statistics is divided by a motion adaptive weighting sum SW′ by the divider 1040 to generate the exposure statistics. FIG. 10B is a block diagram of an exposure statistics sub-module 1010-x for a window WDx in the exposure statistics module 422_2 in FIG. 10A. The exposure statistics sub-module 1010-x comprises an RGB-to Y converter 1011-x and an accumulator 1013-x. The RGB-to-Y converter 1011-x converts RGB pixel values into luminance values (referring to pixel values hereinafter). The accumulator 1013-x accumulates pixel values of all pixels in the window WDx to generate a window exposure statistics ES_{WDx}. FIG. 10C is a block diagram of a weighting generator 1050-x for the window WDx in the exposure statistics module 422_2 in FIG. 10A. The weighting generator 1050-x comprises a comparator 1016-x, an accumulator 1017-x and a multiplier 1018-x. The comparator compares a motion index of each pixel in the window WDx with a motion index threshold value THM. If the motion index is larger than the motion index threshold value THM, the comparator outputs a value of 1. If the motion index is not larger than the motion index threshold value THM, the comparator outputs a value of 0. The accumulator 1017-x accumulates output values of the comparator to generate a motion weighting MWx for the window WDx. The multiplier 1018-x multiples the weighting Wx by the motion weighting for the window WDx to generate the motion adaptive weighting W′x for the window WDx. Take the exposure statistics ES1 of an example, the exposure statistics ES1 is collected by the exposure statistics module 422_2 according to:

$${Y}_{i , j ∈ WDx} = 0.299 \times {R}_{i , j ∈ WDx} + 0.587 \times {G}_{i , j ∈ WDx} + 0.114 \times {B}_{i , j ∈ WDx} ;$$

$${ES}_{WDx} = \sum {Y}_{i , j ∈ WDx} ;$$

$${W}^{′} x = MWx \times Wx ;$$

$${SW}^{′} = {\sum }_{x = 1}^{N} {W}^{′} x ; and$$

$$ES 1 = \frac{{\sum }_{x = 1}^{N} {W}^{′} x \times {ES}_{WDx}}{{SW}^{′ }} .$$

Referring back to FIG. 4, the focus statistics module 423 applies the motion index of each pixel of the HDR image data to an auto focus evaluation function to collect focus statistics of the HDR image data. Then, the auto focus control unit 440 performs the auto focus control process based on the focus statistics received from the focus statistics module 423 to adjust the focal length of the lens 400. Take a Laplacian evaluation function as an example, Laplacian operator calculates the image data through the second order differential operation as the following template:

$$( \begin{matrix}- 1 & - 4 & - 1 \\ - 4 & 20 & - 4 \\ - 1 & - 4 & - 1\end{matrix} ) .$$

The motion index of each pixel is applied to the Laplacian evaluation function to obtain a motion adaptive Laplacian evaluation function ƒ′(k) according to:

$${f}^{′} ( k ) = {\sum }_{i = 1}^{A} {\sum }_{j = 1}^{B} {M}_{i , j} \times {P}_{i , j}^{{L}^{2}} ; and$$

$${P}_{i , j}^{L} = 20 {P}_{i , j} - 4 ( {P}_{i - 1 , j} + {P}_{i + 1 , j} + {P}_{i , j - 1} + {P}_{i , j + 1} ) - ( {P}_{i - 1 , j - 1} + {P}_{i - 1 , j + 1} + {P}_{i + 1 , j - 1} + {P}_{j + 1 , j + 1} ) ,$$

wherein P_{i,j} denotes a pixel value of a pixel at the position (i,j) of the HDR image data, A is a number of rows of pixels in the HDR image data and B is a number of columns of pixels in the HDR image data.

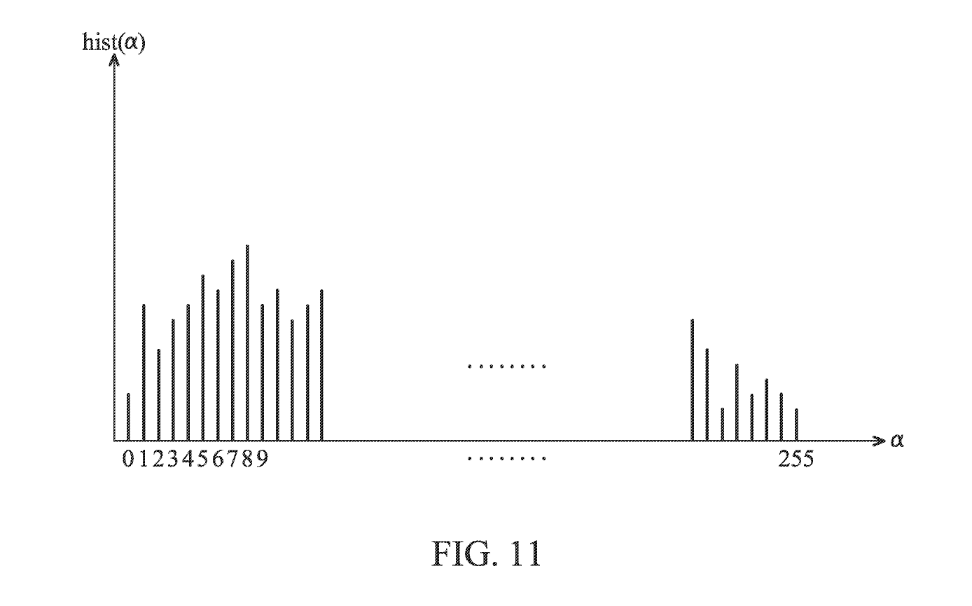

Referring back to FIG. 4, the contrast enhancement module 424 multiplies a pixel value of each pixel of the HDR image data by the corresponding motion index to obtain a motion adaptive HDR image data and performs the contrast enhancement process based on the motion adaptive HDR image data. The contrast enhancement module 424 generates a histogram of the motion adaptive HDR image data and then performs the contrast enhancement process by applying histogram equalization on the histogram. FIG. 11 is a block diagram of the histogram of the motion adaptive HDR image data according to an embodiment of the invention. The histogram is generated according to:

$$for α = 0 \sim G \text{:}$$

$$hist ( α ) = {\sum }_{i = 1}^{A} {\sum }_{j = 1}^{B} {M}_{i , j} \times {H}_{α} ( {P}_{i , j} ) ; and$$

$$\{ \begin{matrix}{H}_{α} ( x ) = 1 , & if x = α \\ {H}_{α} ( x ) = 0 , & otherwise\end{matrix} .$$

G is the highest pixel value (highest luminance value) of the imaging system. For example, in an 8-bit imaging system, G is equal to 255, as shown in FIG. 11.

As described above, weightings of statistics used in image processing such as the exposure statistics, the focus statistics and the histogram described above are adjusted according to motion indexes of an image while improving the dynamic range of the image. Therefore, objects in motion in the image are preferably shown and emphasized.

Methods and apparatus of the present disclosure, or certain aspects or portions of embodiments thereof, may take the form of a program code (i.e., instructions) embodied in non-transitory storage media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

In one embodiment, the invention provides a computer program product embodied in a non-transitory storage medium and loaded by an electronic apparatus to execute a motion adaptive imaging control method applied to a complementary metal oxide semiconductor (CMOS) imaging system. The computer program product comprises: a first code, obtaining a first image data of a scene corresponding to a first exposure value and a second image data of the scene corresponding to a second exposure value, wherein the first exposure value is larger than the second exposure value; a second code, determining a motion index of each pixel of a high dynamic range (HDR) image data according to a pixel value difference between a first pixel value of a corresponding pixel of the first image data and a second pixel value of a corresponding pixel of the second image data; and a third code, performing an auto exposure control process, an auto focus control process and a contrast enhancement process according to the motion index of each pixel, the first image data and the second image data.

The computer program product further comprises: a fourth code, collecting first exposure statistics ES1 of the first image data and second exposure statistics ES2 of the second image data according to

$$ES 1 = \frac{{\sum }_{x = 1}^{N} {\sum }_{j ∈ WDx} Wx \times {M}_{i , j} \times {P}_{i , j}^{1}}{{\sum }_{x = 1}^{N} {\sum }_{i , j ∈ WDx} {M}_{i , j}} and$$

$$ES 2 = \frac{{\sum }_{x = 1}^{N} {\sum }_{i , j ∈ WDx} Wx \times {M}_{i , j} \times {P}_{i , j}^{2}}{{\sum }_{x = 1}^{N} {\sum }_{i , j ∈ WDx} {M}_{i , j }} ,$$

respectively, wherein the first image data and the second image data are divided into N windows, Wx denotes a weighting corresponding to a window WDx, M_{i,j} denotes a motion index of a pixel P_{i,j} of the HDR image data, P¹_{i,j} denotes a pixel value of the first image data and P²_{i,j} denotes a pixel value of the second image data; and a fifth code, performing the auto exposure control process based on the first exposure statistics ES1 and the second exposure statistics ES2 to adjust the first exposure value and the second exposure value.

The computer program product may further comprise a sixth code, determining a pixel value of each pixel of the HDR image data according to the first pixel value, the second pixel value and the corresponding motion index.

The computer program product may further comprise: a seventh code, applying the motion index of each pixel of the HDR image data to an auto focus evaluation function to perform the auto focus control process; an eighth code, multiplying a pixel value of each pixel of the HDR image data by the corresponding motion index to obtain a motion adaptive HDR image data; and a ninth code, performing the contrast enhancement process based on the motion adaptive HDR image data.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion adaptive imaging control method applied to a complementary metal oxide semiconductor (CMOS) imaging system, comprising:
obtaining a first image data of a scene corresponding to a first exposure value and a second image data of the scene corresponding to a second exposure value, wherein the first exposure value is larger than the second exposure value;
determining a motion index of each pixel of a high dynamic range (HDR) image data according to a pixel value difference between a first pixel value of a corresponding pixel of the first image data and a second pixel value of a corresponding pixel of the second image data; and
performing any combination of an auto exposure control process, an auto focus control process and a contrast enhancement process according to the motion index of each pixel, the first image data and the second image data.

2. The method as claimed in claim 1, wherein the auto exposure control process comprises:
collecting first exposure statistics ES1 of the first image data and second exposure statistics ES2 of the second image data according to
$$ES 1 = \frac{{\sum }_{x = 1}^{N} {\sum }_{i , j ∈ WDx} Wx \times {M}_{i , j} \times {P}_{i , j}^{1}}{{\sum }_{x = 1}^{N} {\sum }_{i , j ∈ WDx} {M}_{i , j}} and$$
$$ES 2 = \frac{{\sum }_{x = 1}^{N} {\sum }_{i , j ∈ WDx} Wx \times {M}_{i , j} \times {P}_{i , j}^{2}}{{\sum }_{x = 1}^{N} {\sum }_{i , j ∈ WDx} {M}_{i , j}} ,$$
respectively, wherein the first image data and the second image data are divided into N windows, Wx denotes a weighting corresponding to a window WDx, M_{i,j} denotes a motion index of a pixel P²_{i,j} of the HDR image data, P¹_{i,j} denotes a pixel value of the first image data and P²_{i,j} denotes a pixel value of the second image data; and
adjusting the first exposure value and the second exposure value based on the first exposure statistics ES1 and the second exposure statistics ES2.

3. The method as claimed in claim 1, further comprising:
determining a pixel value of each pixel of the HDR image data according to the first pixel value, the second pixel value and the corresponding motion index.

4. The method as claimed in claim 1, wherein the auto focus control process comprises:
applying the motion index of each pixel of the HDR image data to an auto focus evaluation function.

5. The method as claimed in claim 1, wherein the contrast enhancement process comprises:
multiplying a pixel value of each pixel of the HDR image data by the corresponding motion index to obtain a motion adaptive HDR image data,
wherein the contrast enhancement process is performed based on the motion adaptive HDR image data.

6. A motion adaptive complementary metal oxide semiconductor (CMOS) imaging system, comprising:
a lens;
an image sensing array, capturing image data of a scene using a first exposure value and a second exposure value, wherein the first exposure value is larger than the second exposure value; and
an image processor, coupled to the image sensing array, receiving the image data and generating a first image data of the scene corresponding to the first exposure value and a second image data of the scene corresponding to the second exposure value, comprising:
a motion detector, determining a motion index of each pixel of a high dynamic range (HDR) image data according to a pixel value difference between a first pixel value of a corresponding pixel of the first image data and a second pixel value of a corresponding pixel of the second image data,
wherein the motion adaptive CMOS imaging system performs any combination of an auto exposure control process, an auto focus control process and a contrast enhancement process according to the motion index of each pixel, the first image data and the second image data.

7. The motion adaptive CMOS imaging system as claimed in claim 6, wherein the image processor further comprises:
at least one exposure statistics module, coupled to at least one auto exposure control unit of the motion adaptive CMOS imaging system, collecting first exposure statistics ES1 of the first image data and second exposure statistics ES2 of the second image data according to
$$ES 1 = \frac{{\sum }_{x = 1}^{N} {\sum }_{i , j ∈ WDx} Wx \times {M}_{i , j} \times {P}_{i , j}^{1}}{{\sum }_{x = 1}^{N} {\sum }_{i , j ∈ WDx} {M}_{i , j}} and$$
$$ES 2 = \frac{{\sum }_{x = 1}^{N} {\sum }_{i , j ∈ WDx} Wx \times {M}_{i , j} \times {P}_{i , j}^{2}}{{\sum }_{x = 1}^{N} {\sum }_{i , j ∈ WDx} {M}_{i , j}} ,$$
respectively, wherein the first image data and the second image data are divided into N windows, Wx denotes a weighting corresponding to a window WDx, M_{i,j} denotes a motion index of a pixel P_{i,j} of the HDR image data, P¹_{i,j} denotes a pixel value of the first image data and P²_{i,j} denotes a pixel value of the second image data,
wherein the at least one auto exposure control unit adjusts the first exposure value and the second exposure value based on the first exposure statistics ES1 and the second exposure statistics ES2.

8. The motion adaptive CMOS imaging system as claimed in claim 6, wherein the image processor further comprises:
a HDR image generator, determining a pixel value of each pixel of the HDR image data according to the first pixel value, the second pixel value and the corresponding motion index.

9. The motion adaptive CMOS imaging system as claimed in claim 6, wherein the image processor further comprises:
a focus statistics module, coupled to an auto focus control unit of the motion adaptive CMOS imaging system, applying the motion index of each pixel of the HDR image data to an auto focus evaluation function to collect focus statistics,
wherein the auto focus control unit performs the auto focus control process based on the focus statistics.

10. The motion adaptive CMOS imaging system as claimed in claim 6, wherein the motion adaptive CMOS imaging system further comprises:
a contrast enhancement module, multiplying a pixel value of each pixel of the HDR image data by the corresponding motion index to obtain a motion adaptive HDR image data and performing the contrast enhancement process based on the motion adaptive HDR image data.

11. A computer program product, embodied in a non-transitory storage medium and loaded by an electronic apparatus to execute a motion adaptive imaging control method applied to a complementary metal oxide semiconductor (CMOS) imaging system, comprising:
a first code, obtaining a first image data of a scene corresponding to a first exposure value and a second image data of the scene corresponding to a second exposure value, wherein the first exposure value is larger than the second exposure value;
a second code, determining a motion index of each pixel of a high dynamic range (HDR) image data according to a pixel value difference between a first pixel value of a corresponding pixel of the first image data and a second pixel value of a corresponding pixel of the second image data; and
a third code, performing any combination of an auto exposure control process, an auto focus control process and a contrast enhancement process according to the motion index of each pixel, the first image data and the second image data.

12. The computer program product as claimed in claim 11, wherein the third code further comprises:
a fourth code, collecting first exposure statistics ES1 of the first image data and second exposure statistics ES2 of the second image data according to
$$ES 1 = \frac{{\sum }_{x = 1}^{N} {\sum }_{i , j ∈ WDx} Wx \times {M}_{i , j} \times {P}_{i , j}^{1}}{{\sum }_{x = 1}^{N} {\sum }_{i , j ∈ WDx} {M}_{i , j}} and$$
$$ES 2 = \frac{{\sum }_{x = 1}^{N} {\sum }_{i , j ∈ WDx} Wx \times {M}_{i , j} \times {P}_{i , j}^{2}}{{\sum }_{x = 1}^{N} {\sum }_{i , j ∈ WDx} {M}_{i , j}} ,$$
respectively, wherein the first image data and the second image data are divided into N windows, Wx denotes a weighting corresponding to a window WDx, M_{i,j} denotes a motion index of a pixel P_{i,j} of the HDR image data, P¹_{i,j} denotes a pixel value of the first image data and P²_{i,j} denotes a pixel value of the second image data; and
a fifth code, adjusting the first exposure value and the second exposure value based on the first exposure statistics ES1 and the second exposure statistics ES2.

13. The computer program product as claimed in claim 11, further comprising:
a sixth code, determining a pixel value of each pixel of the HDR image data according to the first pixel value, the second pixel value and the corresponding motion index.

14. The computer program product as claimed in claim 11, wherein the third code further comprises:
a seventh code, applying the motion index of each pixel of the HDR image data to an auto focus evaluation function to perform the auto focus control process.

15. The computer program product as claimed in claim 11, wherein the third code further comprises:
an eighth code, multiplying a pixel value of each pixel of the HDR image data by the corresponding motion index to obtain a motion adaptive HDR image data; and
a ninth code, performing the contrast enhancement process based on the motion adaptive HDR image data.
